(19) United States
(12) Patent Application Publication
(10) Pub. No.: US 2011/0308434 A1
(43) Pub. Date: Dec. 22, 2011

(54) LOCKER FOR USE WITH CHAIR

(76) Inventor: Timothy Holobinko, Naples, FL (US)

(21) Appl. No.: 13/164,053

(22) Filed: Jun. 20, 2011

Related U.S. Application Data
(63) Continuation-in-part of application No. 12/818,576, filed on Jun. 18, 2010, now abandoned.

(51) Int. Cl. E05G 1/024; E05G 1/026; E05G 1/02

(52) U.S. Cl. 109/23; 109/58; 109/50; 109/64

(57) ABSTRACT

A locker configured for releasable attachment to a rail is disclosed. The locker includes a plurality of walls that define a storage compartment. A first locking mechanism is accessible from an exterior of the compartment and has a locked position that secures a moveable member in a closed position across an opening to the storage compartment. A mating member is configured to engage a securing member that is configured to be secured to the rail. A second locking mechanism is adjacent to one of the walls, is aligned with the mating member, and has a locked position that locks the mating member to the securing member to lock the securing member to the rail. Optionally, a housing is adjacent to one of the walls, wherein the second locking mechanism is positioned in the housing. Second locking mechanism cannot be accessed unless first locking mechanism is unlocked.

### CLAIM OF PRIORITY

This application is a continuation-in-part of U.S. application Ser. No. 12/818,576, filed on Jun. 10, 2010.

### BACKGROUND

Many people who go to a beach or a public swimming pool carry with them valuable personal items such as Kindles®, iPODs®, papers, files, cell phones, keys, money, credit cards and the like. However, such public venues fail to offer a secure place to store these valuable items and as a result, many people end up leaving their valuables vulnerable to theft by leaving the valuables unattended in plain view or hiding them in predictable places such as under a beach towel or in their shoes. Thus, there is a need for a convenient, non-cumbersome device that secures valuables and that can be easily attached to a beach or lawn chair.

### SUMMARY

In an embodiment, a locker configured for attachment and detachment from a rail is disclosed. In particular, the locker is attachable to the rail of a chair. However, the locker can be useful with other rails such as those on beds, tables, stand posts, fences, ladders, or any other structure which has a rail and could be appropriate or desirable which to removably attach a locker. The locker includes two locking mechanisms. A first locking mechanism locks the locker's storage compartment and a second locking mechanism locks the locker to a securing member that is connected to the rail. In an embodiment, second locking mechanism cannot be accessed unless first locking mechanism is unlocked.

In an embodiment, the locker includes a plurality of walls that define a storage compartment. A first locking mechanism is accessible from an exterior of the compartment and has a locked position that secures a moveable member across an opening to the storage compartment to make the storage compartment inaccessible. The storage compartment is accessible when the first locking mechanism is in an unlocked position. A second locking mechanism has a locked position that secures a securing member to the rail when the securing member is connected to one of the walls. When second locking mechanism is in an unlocked position, securing member is disconnectable from the wall and the locker is detachable from the rail.

In another embodiment, the locker has a plurality of walls defining a storage compartment, wherein one of the walls includes a mating member configured to engage a securing member that is configured to engage a rail. A lock assembly has first and second locking mechanisms. The first locking mechanism has a locked position that secures a moveable member in a closed position to make the storage compartment inaccessible and an unlocked position that releases the moveable member and makes the compartment accessible. The second locking mechanism is configured to lock the mating member to the securing member to lock the storage compartment to the rail when the mating member and the securing member are engaged. When second locking mechanism is in an unlocked position, securing member is disconnectable from the mating member and the locker is detachable from the rail.

In another embodiment, a locker in combination with a chair having a rail is disclosed. The locker includes a plurality of walls defining a storage compartment and a moveable member. A first locking mechanism has a locked position that secures the moveable member across an opening to the storage compartment and an unlocked position that releases the moveable member to make the storage compartment accessible. A securing member has a first portion configured to engage the rail and a second portion configured to engage a mating member that connects the securing member to the storage compartment. A second locking mechanism has a locked position that secures the second portion of the securing member to the mating member to lock the compartment to the rail. When second locking mechanism is in an unlocked position, second portion of the securing member is disconnectable from the mating member and the locker is detachable from the rail.

In another embodiment, a locker is disclosed. The locker has a plurality of walls defining a storage compartment. A moveable member is adjacent to at least one of the walls. A mating member is configured to engage a securing member. A first locking mechanism is accessible from an exterior of the compartment and has a locked position that secures the moveable member in a closed position across an opening to the storage compartment. A second locking mechanism is adjacent to one of the walls, is aligned with the mating member, and has a locked position that locks the mating member to the securing member. When second locking mechanism is in an unlocked position, securing member is disconnectable from the mating member and the locker is detachable from the rail.

In another embodiment, the locker has a plurality of walls defining a storage compartment. A housing is adjacent to at least one of the walls and includes a mating member configured to engage a securing member. A moveable member is adjacent to at least one of the walls. A first locking mechanism is accessible from an exterior of the compartment and has a locking position that secures the moveable member in a closed position across an opening to the storage compartment. The storage compartment is accessible when first locking mechanism is in an unlocked position. A second locking mechanism has a locked position that locks the mating member to the securing member. When second locking mechanism is in an unlocked position, securing member is disconnectable from the mating member and the locker is detachable from the rail.

These and other details, objects, and advantages of the disclosed locker will become better understood or apparent from the following descriptions, examples, and figures showing embodiments thereof.

### BRIEF DESCRIPTION OF THE FIGURES

In the drawings which are attached hereto and made a part of this disclosure:

FIG. 1 shows a front perspective view of an embodiment of a locker in combination with a securing member for use with a pool chair showing the locker in the closed position;

FIG. 2 shows a front perspective view of the embodiment of the locker shown in FIG. 1 in the opened position;

FIG. 3 shows a side perspective view of the embodiment of the locker shown in FIG. 1 in the opened position;

FIG. 4 shows a side view of the embodiment of the locker shown in FIG. 1 in the opened position;

FIG. 5 shows a side perspective view of another embodiment of a locker in combination with a securing member showing the locker in the opened position;

FIG. 6 shows a side perspective view of another embodiment of a locker in combination with a securing member showing the locker in the closed position;

FIG. 7 shows a side perspective view of the embodiment of the locker shown in FIG. 6 in the opened position;

FIGS. 8A-8C show the embodiment of the securing member shown in FIGS. 1-7, 9-15 used to secure the locker to the chair rail, where FIG. 8A shows a perspective view, FIG. 8B shows a side view, and FIG. 8C shows a side perspective view;

FIG. 9 shows an exploded view of the another embodiment of the locker;

FIG. 10 shows the embodiment of the locker shown in FIG. 1 secured to a side chair rail;

FIG. 11 shows the embodiment of the locker shown in FIG. 1 secured to a back chair rail;

FIG. 12 shows a front perspective view of another embodiment of a locker in combination with a securing member for use with a pool chair showing the locker in the closed position;

FIG. 13 shows a front perspective view of another embodiment of a locker in combination with a securing member for use with a pool chair showing the locker in the closed position;

FIG. 14 shows a front perspective view of another embodiment of a locker in combination with a securing member for use with a pool chair showing the locker in the opened position;

FIG. 15 shows a front perspective view of another embodiment of a locker in combination with a securing member for use with a pool chair showing the locker in the opened position;

FIGS. 16A-16C show another embodiment of the securing member used to secure the locker to the chair rail as shown in FIGS. 17-18, where FIG. 16A shows a perspective view, FIG. 16B shows a side view, and FIG. 16C shows an end view;

FIG. 17 shows a side perspective view of the embodiment of the locker shown in FIG. 1 in combination with the securing member shown in FIG. 16 attached thereto;

FIG. 18 shows an exploded view of the embodiment of the locker shown in FIG. 17;

FIG. 19 shows a side perspective view of another embodiment of a locker in combination with a securing member for use with a pool chair showing the locker in the closed position;

FIG. 20 shows a side perspective view of the embodiment of the locker shown in FIG. 19 in the opened position without the securing member attached;

FIG. 21A shows a cross-sectional side view of the embodiment of the locker shown in FIG. 19 in the closed position; FIG. 21B shows an expanded view of the locking system as designated by B in FIG. 21A; FIG. 21C shows an expanded view of the securing means as designated by C in FIG. 21A; and FIG. 21D shows an expanded view of the hinge means as designated by D in FIG. 21D;

FIG. 22 shows a cross-sectional side view of the embodiment of the locker shown in FIG. 19 in the opened position;

FIG. 23 shows a side perspective view of the embodiment of the locker shown in FIG. 20 in the closed position;

FIG. 24 shows an exploded view of the embodiment of the locker shown in FIG. 20.

### DETAILED DESCRIPTION

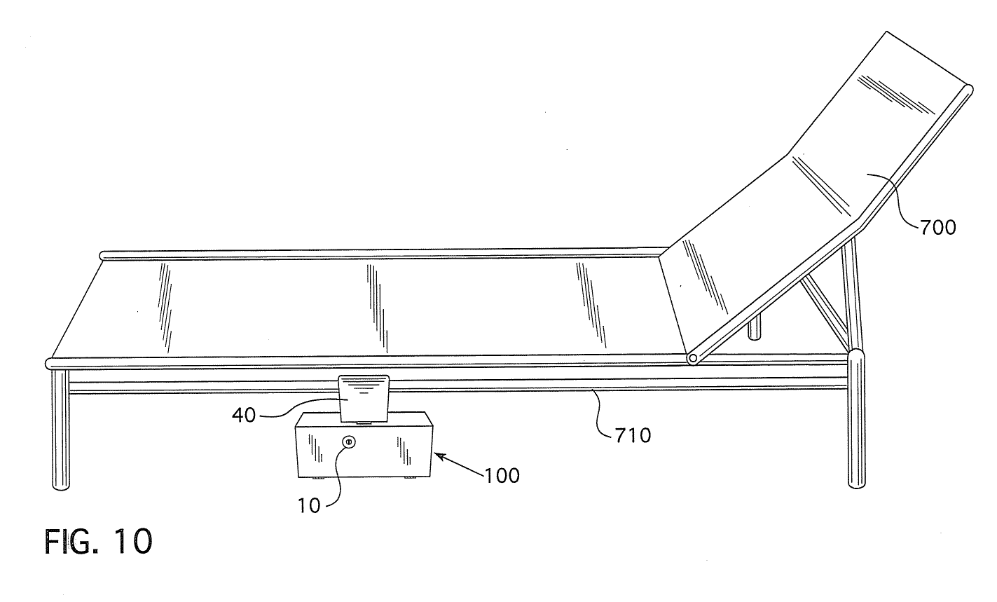

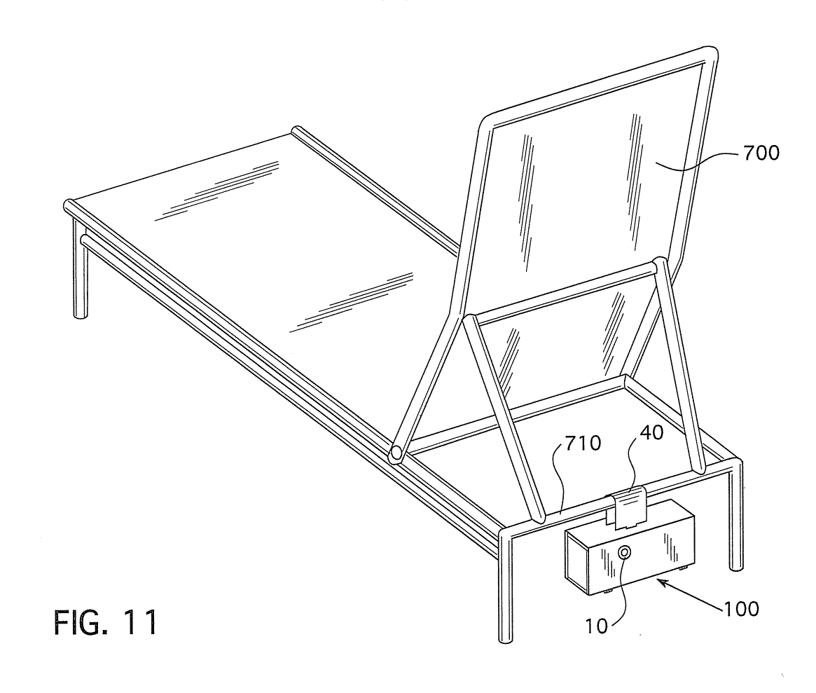

Locker 100, 200 is configured to be detachably secured to a rail of any structure which could be appropriate or desirable which to removably attach a locker. In an embodiment, locker 100, 200 is attached to a chair rail 710, such as a pool or lawn chair 700 shown in FIGS. 10 and 11, or a reclining chair, a lawn chair, a lounge chair, a folding chair, a beach chair, or a sports chair. Embodiments of a locker 100, 200 configured for releasable attachment to a rail are shown generally in the accompanying drawings. The locker 100, 200 has a plurality of walls 1, 2, 3, 4, 5, 6, 201, 202, 203, 204, 205, 206 that define a storage compartment 30, 230 that is configured to store personal items such as keys 310, wallets, sunglasses, money 340, cell phones 350, and other valuables. Each locker 100, 200 has first 10, 210 and second 20, 220 locking mechanisms. The first locking mechanism 10, 210 locks the locker's storage compartment 30, 230 and the second locking mechanism 20, 220 locks the locker 100, 200 to a securing member 40 that is connected to the rail. In an embodiment, second locking mechanism 20, 220 cannot be accessed unless first locking mechanism 10, 210 is unlocked.

In use, first 10, 210 and second 20, 220 locking mechanisms preferably have different keys, combinations, pass codes, or the like in order to control who can unlock each. For example, a vendor may use second locking mechanism 20, 220 to lock locker 100, 200 to a chair rail 710 of a pool chair 700. Vendor then rents locker 100, 200, secured to chair 700, to a person visiting the pool for the day. The renter is given the key, combination, code, or the like to unlock first locking mechanism 10, 210 to have access to storage compartment 30, 230 in order to securely store personal items therein. The renter does not have the key, combination, code or the like to unlock second locking mechanism 20, 220 and therefore cannot remove the locker 100, 200 from the chair rail 710.

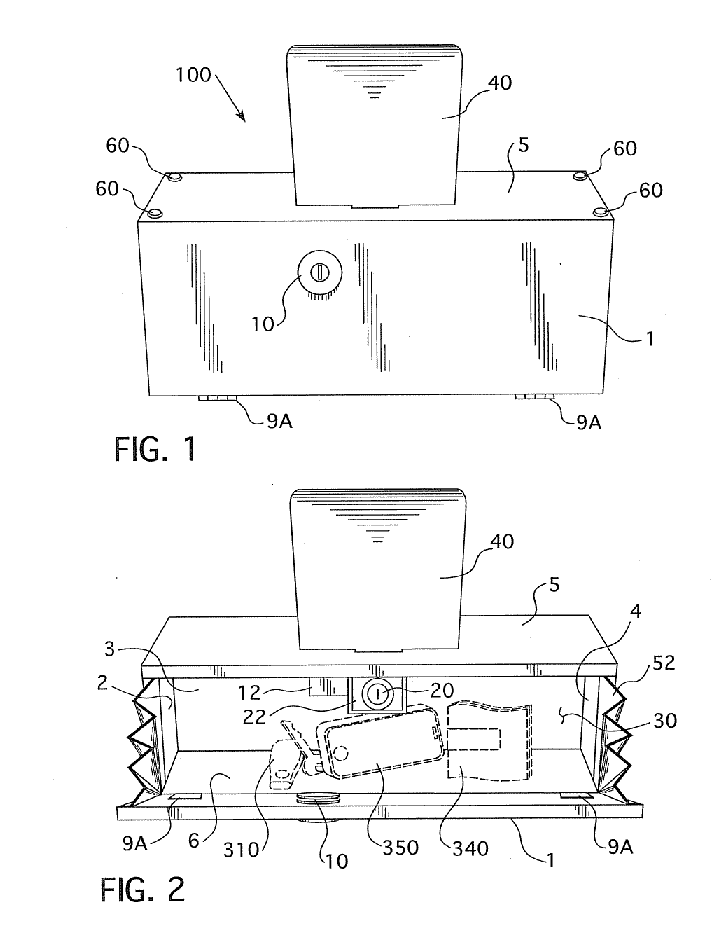

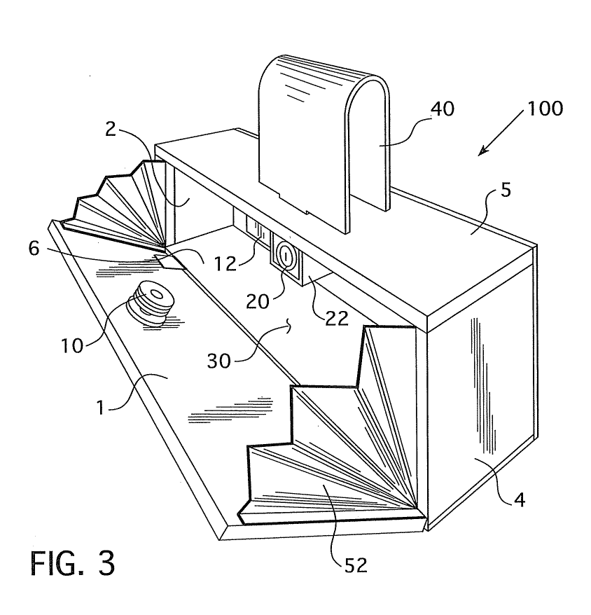

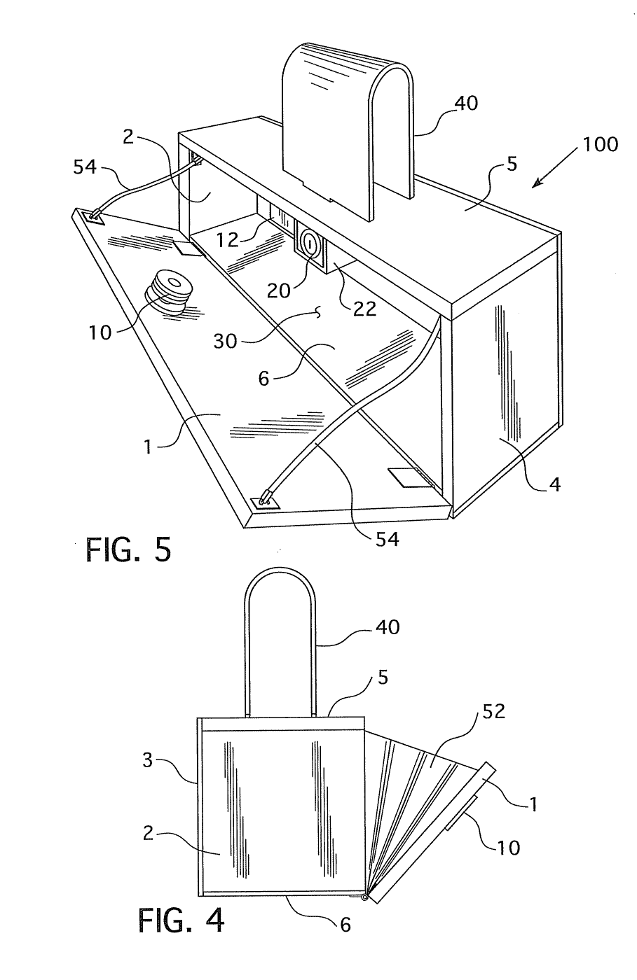

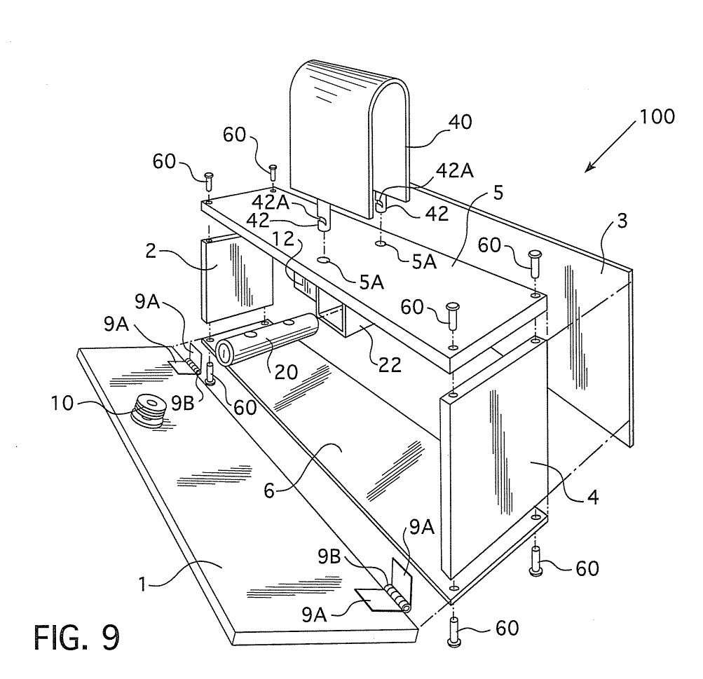

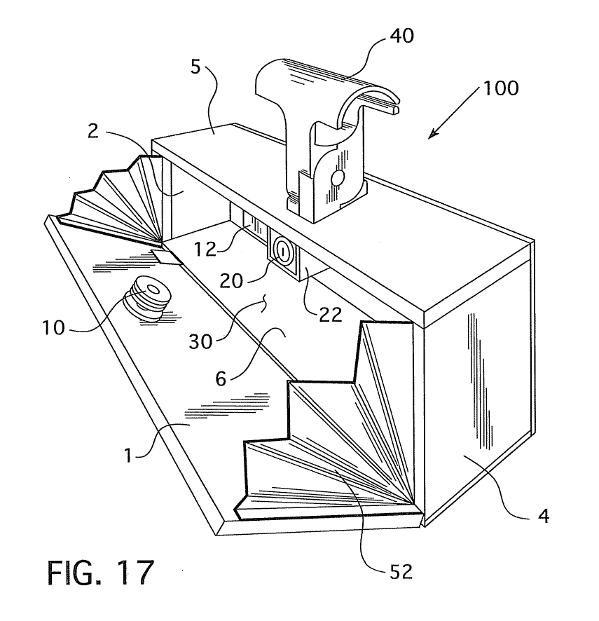

A first embodiment of locker is designated 100 and is shown generally in FIGS. 1-18 of the attached drawings. The locker 100 has a plurality of walls 1, 2, 3, 4, 5, 6 that define the storage compartment 30, including four side walls 1, 2, 3, 4 and top and bottom walls 5, 6. Top and bottom walls 5, 6 are substantially opposed and each adjoin with side walls 1, 2, 3, 4. In an embodiment, at least two of walls 2, 3, 4, 5, 6 are integral with each other and for example, may be constructed of a single piece of molded plastic. In another embodiment, walls 2, 3, 4, 5, 6 are welded together. In another embodiment shown in FIG. 9, walls 1, 2, 3, 4, 5, 6 are secured together by a plurality of rivets or screws 60. As illustrated in the embodiment shown in FIGS. 1-4, one of the walls 1 is moveable between a closed (FIG. 1) and an opened (FIGS. 2-4) position to provide access to the storage compartment 30. In an embodiment, there are hinge receptors 9A on wall 1 and an adjoining wall configured to receive a plurality of hinge pins 9B. In another embodiment, a member 52 (FIGS. 2-4) or a strap 54 (FIG. 5) is mounted to the moveable wall 1 and an adjoining wall 2,4 to limit movement of the moveable wall 1, provide additional strength, and secure items within storage compartment. Optionally, member 52 is corrugated (FIGS. 2, 3).

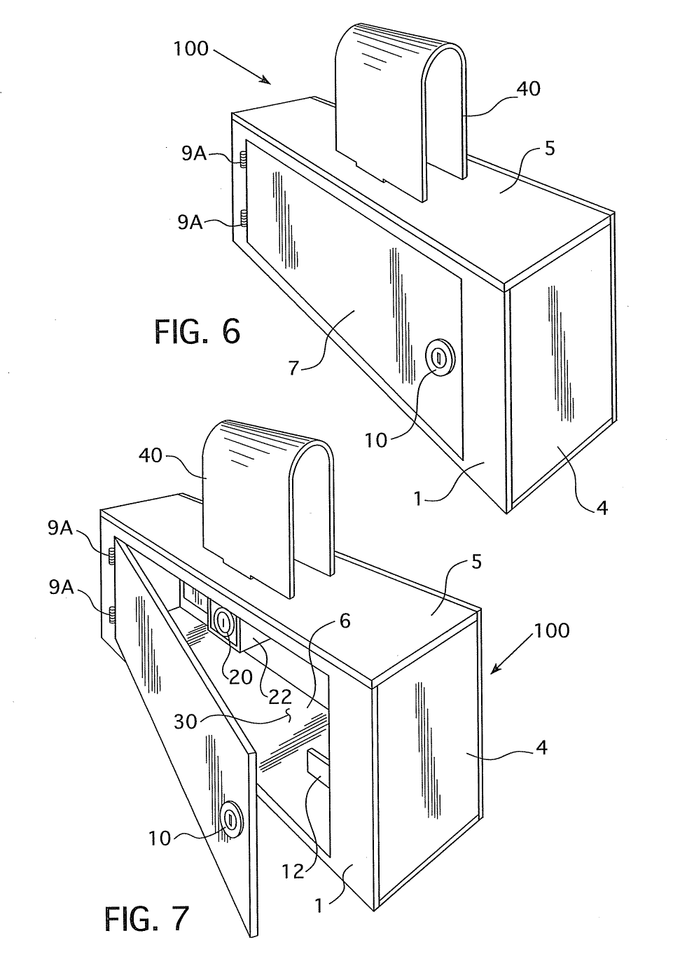

In another embodiment illustrated in FIGS. 6 and 7, there is an opening 8 in one of the walls 1 to the storage compartment 30. A door 7 is sized to cover the opening 8. The door 7 is secured to the wall 1 by hinge pins 9B configured to fit within corresponding hinge receptors 9A on the wall 1 and an adjoining wall.

As shown generally in FIGS. 1-18, the locker 100 has first and second locking mechanisms 10, 20. Each locking mechanism 10, 20 is moveable between a locked and an unlocked position.

First locking mechanism 10 is accessible from the exterior of locker 100 and controls access to an interior of the storage compartment 30. Second locking mechanism 20 is accessible only when first locking mechanism 10 is in the unlocked position thereby making storage compartment 30 accessible. This dual-lock system enables the locker 100 to be locked to the chair rail 710 by locking mechanism 20 with access to locking mechanism 20 being limited, thereby preventing the locker 100 from being removed from the chair rail 710.

A first locking mechanism 10 is attached to the moveable wall 1 or door 7 and is configured to be locked and unlocked from the exterior of the locker 100. The moveable wall 1 or door 7 is secured to make the interior of the storage compartment 30 and second locking mechanism 20 inaccessible from the exterior of the locker 100 when the first locking mechanism 10 is in the locked position (FIGS. 1, 6). The moveable wall 1 or door 7 is released when the first locking mechanism 10 is in the unlocked position, thereby making the storage compartment 30 accessible from the exterior of the locker 100 (FIGS. 2-4, 7).

In an embodiment such as the one shown in FIGS. 1-11, the first locking mechanism 10 is a key lock. When a key turns the key lock to the locked position, a pivot latch (not shown) engages a lock member 12 positioned within the storage compartment 30 to secure the moveable wall 1 or door 7 to make the storage compartment 30 inaccessible. When the key turns the key lock 10 to the unlocked position, the pivot latch disengages the lock member 12 so that the moveable wall 1 or door 7 is released and the storage compartment 30 is accessible.

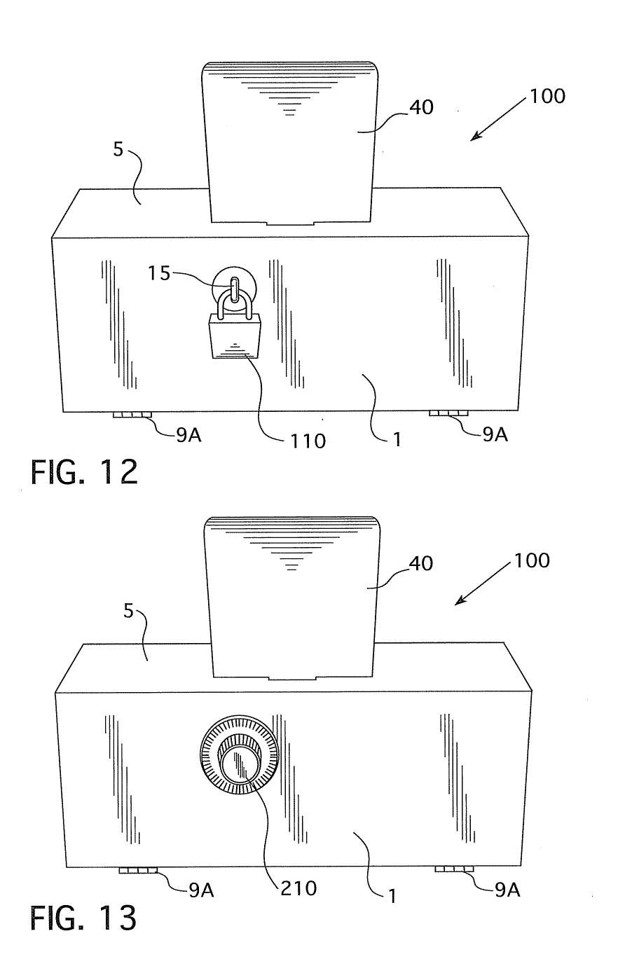

In another embodiment such as the one shown in FIG. 12, the first locking mechanism 10 is a pad lock. A locking member 15 attached to the moveable wall 1 or door 7 is configured to receive the pad lock such that the interior of the storage compartment 30 is inaccessible when the pad lock is inserted into the locking member 15 and moved to the locked position. When the pad lock is unlocked, it can be removed from the locking member 15 to make the storage compartment 30 accessible.

In another embodiment such as the one shown in FIG. 13, the first locking mechanism 10 is a combination lock that is attached to the moveable wall 1 or door 7. The combination lock has a dial that interacts with a plurality of cams each having a notch (not shown). The notches on the cams are misaligned when the combination lock 10 is in the locked position and are aligned when the combination lock 10 is in the unlocked position.

One of the walls 2, 3, 4, 5, 6 includes a mating member configured to engage a securing member 40. In the embodiments shown, securing member 40 has at least one male member and mating member has at least one female member configured to receive male member. In use, the securing member 40 engages a rail 710 on the chair 700 and is secured by a second locking mechanism 20 (described below) to the rail 710 so that the locker 100 cannot be removed from the chair rail 710 when the second locking mechanism 20 is in the locked position. Securing member 40 can be made from stainless steel, aluminum, plastic, or the like.

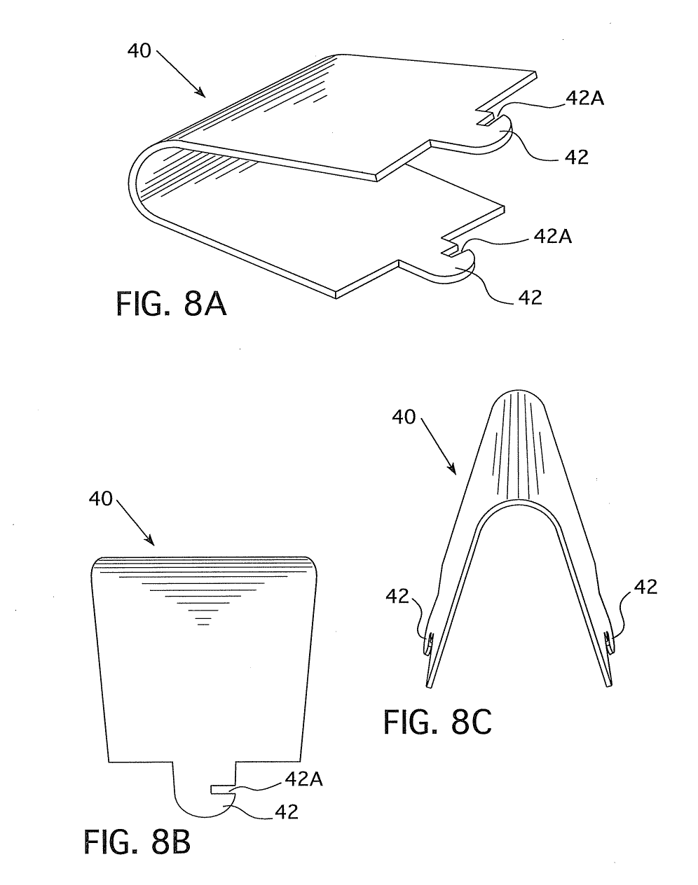

In an embodiment shown in FIGS. 1-15, and particularly in FIGS. 8A-8C and 9, securing member 40 is a C-clamp having a pair of projections 42 configured to be inserted into corresponding holes 5A in the wall 5 and slots 20A in lock 20. Each projection has a notch 42A, illustrated for example in FIGS. 8A-8C. In use, and as shown in FIG. 9, when lock 20 is in the locked position, projections 42 are inserted through holes 5A in wall 5 and into slots 20A in lock 20, notch 42A is engaged so that securing member 40 cannot be removed from slots 5A, thereby preventing chair locker 100 from being removed from chair rail 710. When lock 20 is in the unlocked position, notch 42A is disengaged so that securing member 40 can be removed from holes 5A, thereby enabling chair locker 100 to be removed from chair rail 710.

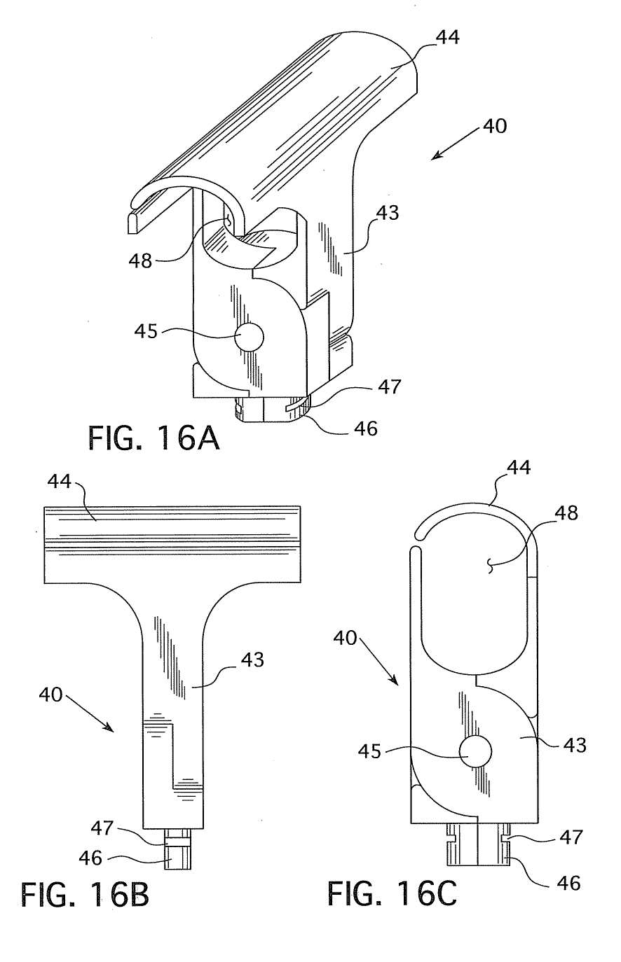

In another embodiment shown in FIGS. 16-18, securing member 40 is a T-shaped clamp that has a first member 44 that is configured to engage chair rail 710 when chair rail 710 is positioned within opening 48. A support member 43 supports first member 44 and pivots around pin 45 to enable first member 44 to be moved from an opened to a closed position to engage chair rail 710. A base 46 having at least one notch 47 is positioned at the proximal end of support member 43. Base 46 is configured for insertion through hole 5A in wall 5 and into slot 20A in lock 20. In use, when base 46 is inserted into slot 20A in lock 20 and lock 20 is in the locked position, notch 47 is engaged so that securing member 40 cannot be removed from hole 5A, thereby preventing chair locker 100 from being removed from chair rail 710. When lock 20 is in the unlocked position, notch 47 is disengaged so that securing member 40 can be removed from hole 5A, thereby enabling chair locker 100 to be removed from chair rail 710.

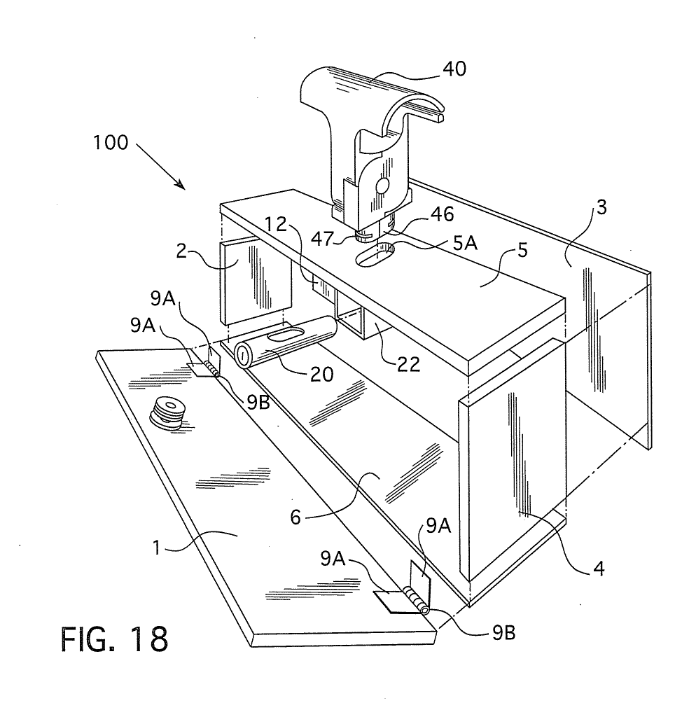

As shown in the figures, a second locking mechanism 20 is positioned in an interior of the storage compartment 30. Optionally, the second locking mechanism 20 is positioned within a housing 22 that is mounted to an interior surface of one of the walls 2, 3, 4, 5, 6. In the locked position, second locking mechanism 20 secures the securing member 40 to the chair rail 710 to prevent removal of the locker 100 therefrom. In the unlocked position, second locking mechanism 20 releases the securing member 40 to facilitate removal of the locker 100 from the chair rail 710. In the embodiment shown in FIGS. 9 and 18, second locking mechanism 20 is sized to fit within housing 22. Lock body has at least one slot 20A therein configured to receive projections 42 (FIG. 9) or base 46 (FIG. 18) of the securing member 40. As described above, in use, projections 42 or base 46 are inserted into the slot 20A and the locking mechanism 20 is positioned to lock the securing member 40 in place to secure the securing member 40 to the chair rail 710.

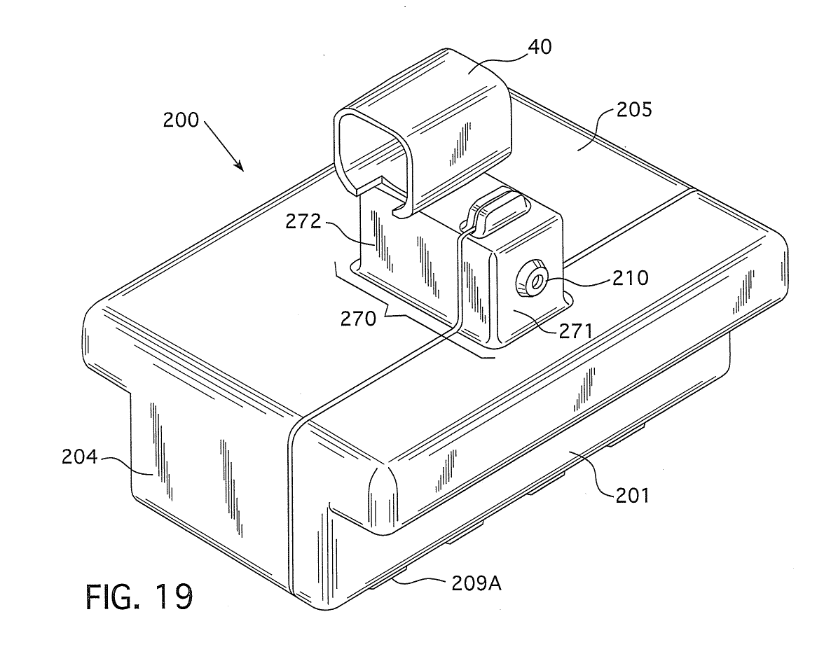

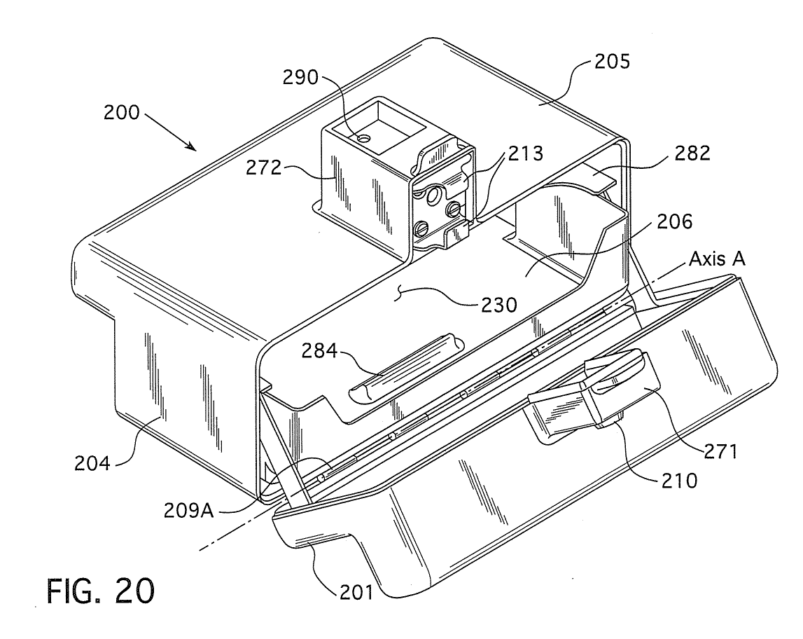

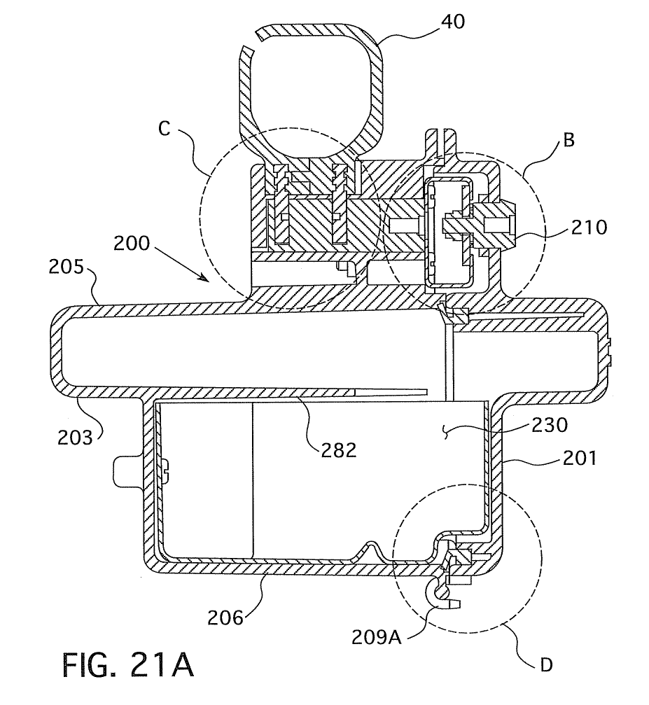

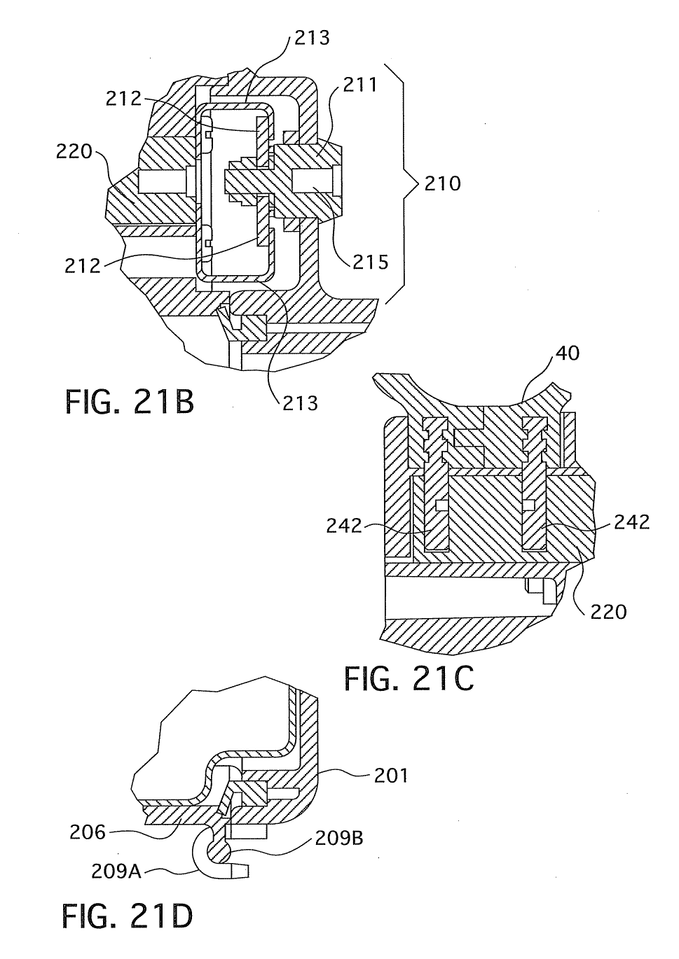

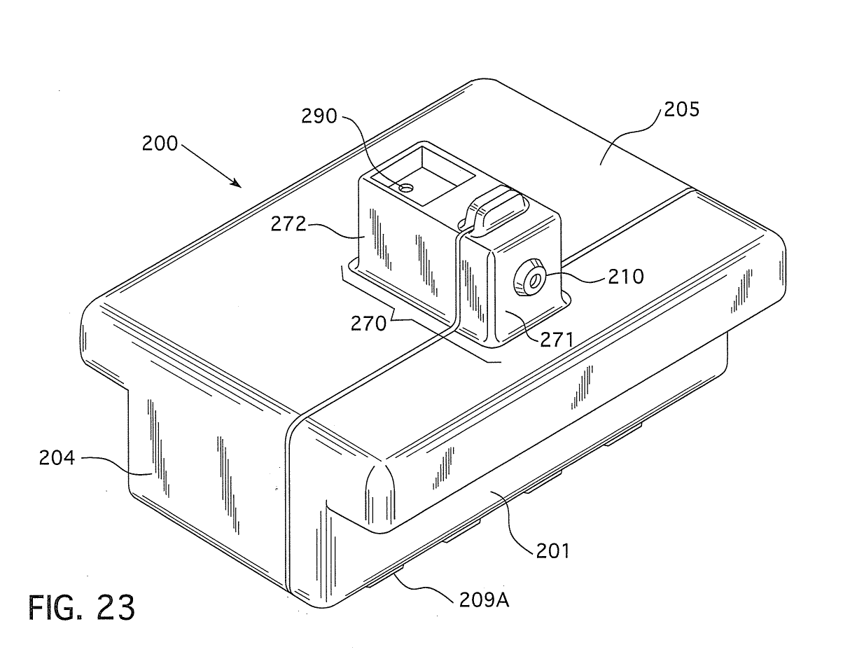

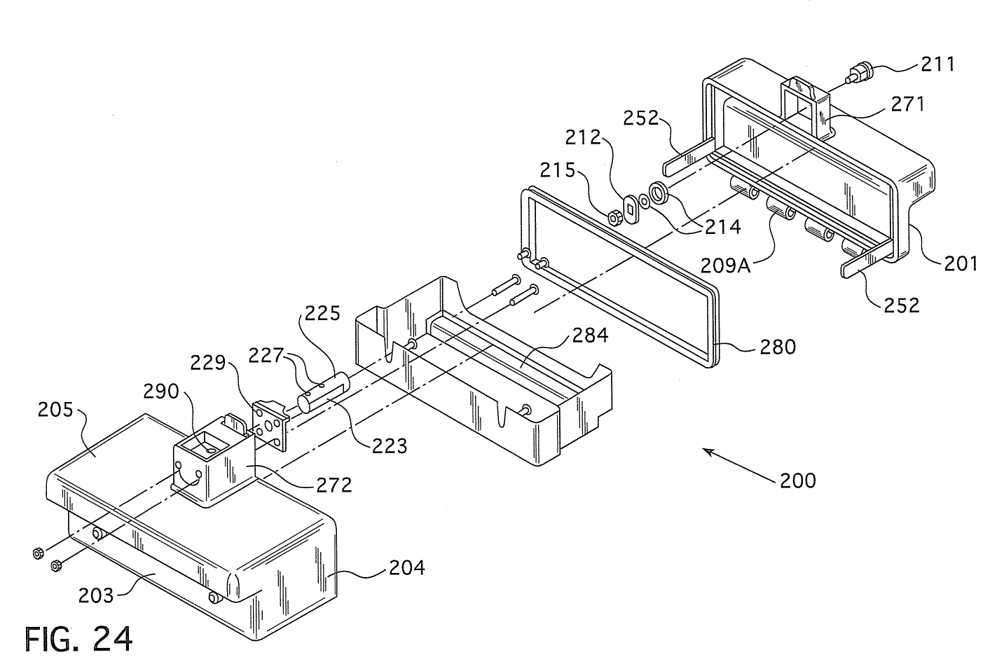

Another embodiment of locker is designated 200 and is shown generally in FIGS. 19-24 of the attached drawings. The locker 200 has a plurality of walls 201, 202, 203, 204, 205, 206 that define the storage compartment 230, including four side walls 201, 202, 203, 204 and top and bottom walls, 205 and 206, respectively. Top and bottom walls 205, 206 are substantially opposed and each adjoins with side walls 201, 202, 203, 204. In an embodiment shown in FIG. 24, at least two of walls 202, 203, 204, 205, 206 are integral with each other and for example, may be constructed of a single piece of molded plastic. In other embodiments (not shown), walls 202, 203, 204, 205, 206 are welded together or are secured together by a plurality of rivets or screws. As illustrated in FIGS. 19-24, one of the walls 201 is moveable between a closed (FIGS. 19, 23) and an opened (FIG. 20) position to provide access to the storage compartment 230. There are hinge receptors 209A on wall 201 and an adjoining wall configured to receive a plurality of hinge pins 209B (see FIGS. 21A, 21D). Moveable wall 201 moves about an axis A that is positioned in a plane in which compartment 230 is positioned. Optionally, as shown in FIGS. 20, 24, a member 252 is mounted to the moveable wall 201 and an adjoining wall 202, 204 to limit movement of the moveable wall 201, provide additional strength, and secure items within storage compartment.

In another embodiment, there is an opening (not shown) in one of the walls to the storage compartment 230 and a door (not shown) is sized to cover the opening, where door is secured to at least one of the walls by any means known to those skilled in the art.

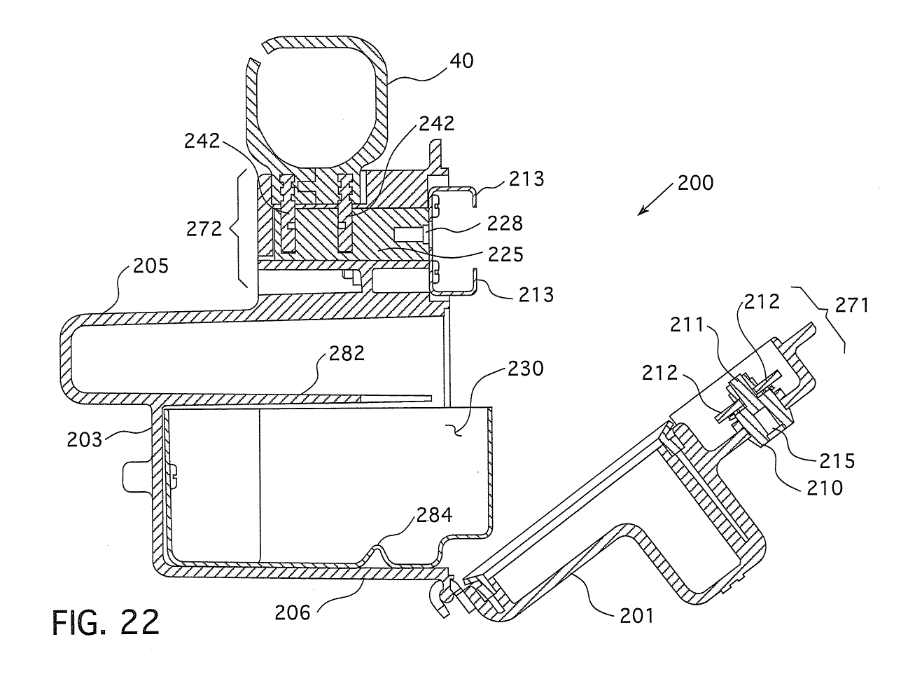

Optionally, locker 200 includes a housing 270 that is adjacent to at least one of the walls 202, 203, 204, 205, 206, as shown in FIGS. 19-24. In the embodiment shown, housing 270 is positioned exterior to the storage compartment 230 in order to substantially seal compartment 230 and to provide additional strength and integrity to the connection with the securing member. In another embodiment, housing 270 is positioned in an interior of the storage compartment 230 (not shown). Optionally, as shown, housing 270 is integral with at least a portion of at least one of the walls 205. In other embodiments (not shown) housing 270 is connected to at least a portion of at least one of the walls 201, 202, 203, 204, 205, 206. As shown in FIG. 22, housing 270 may include first 271 and second 272 portions, second portion 272 being accessible from the first portion 271. In the embodiments shown, first portion 272 is connected to the moveable wall 201.

As shown generally in FIGS. 19-24, the locker 200 has first and second locking mechanisms 210, 220. Each locking mechanism 210, 220 has a locked and an unlocked position.

A portion of first locking mechanism 210 is accessible from the exterior of locker 200 and controls access to an interior of the storage compartment 230. Second locking mechanism 220 is accessible only when first locking mechanism 210 is in the unlocked position thereby making storage compartment 230 accessible.

A first locking mechanism 210 is configured to be locked and unlocked from the exterior of the storage compartment 230. In the embodiments shown in FIGS. 19-24, first locking mechanism 210 includes a cam 211 that has a channel 215 that is accessible from an exterior of the storage compartment 230 for receiving a key (not shown). See FIG. 22. Cam 211 turns when key is turned in channel 215. Cam 211 is connected to a latch 212 by a plurality of washers 214 and nuts 215 such that latch 212 turns when cam 211 turns. Latch 212 is configured to engage a latching member 213 when first locking mechanism is in the locked position and to disengage latching member 213 when the first locking mechanism is in the unlocked position. In the embodiments shown in FIGS. 19-24, cam 211 and latch 212 are positioned in first portion 271 of housing 270 and latching member 213 is positioned in second portion 272 of housing 270. In the embodiment shown in FIGS. 19-24, when latch 212 engages latching member 213, moveable wall 201 is secured to close storage compartment 230, thereby making storage compartment 230 and second locking mechanism 220 inaccessible from the exterior of the locker 200 (FIGS. 19, 23). Moveable wall 201 is able to rotate about axis A when latch 212 is disengaged from latching member 213, thereby making storage compartment 230 and second locking mechanism 220 accessible (FIGS. 20, 22).

In an embodiment such as the one shown generally in FIGS. 19-24, housing 270 includes a mating member 290 such as a female portion configured to engage a male portion such as projections 242, of securing member so that securing member is connected to housing 270 (which is connected to at least a portion of one of the walls 202, 203, 204, 205, 206) and to chair rail 710.

In another embodiment (not shown), one of the walls 202, 203, 204, 205, 206 includes a mating member such as a female portion configured to engage a portion of securing member 40 such as a male portion so that securing member 40 is connected to one of walls 202, 203, 204, 206, 206 and to chair rail 710.

In the embodiments shown in FIGS. 19-24, second locking mechanism is positioned in housing 270, although second locking mechanism 220 may be positioned in compartment 230 (not shown). Second locking mechanism 220 is substantially aligned with mating member 290. In use, second locking mechanism 220 secures securing member 40 to mating member 290 when securing member and mating member are connected and second locking mechanism 220 is in the locked position. In the embodiments shown, second locking member 220 includes a cam 221 that has a channel 228 that is accessible from an interior of housing 270 and that is configured to receive a key (not shown). Cam 221 turns when key is turned in channel 228. Cam 221 is connected to a cylinder 225 that includes a slot for receiving a portion of securing member 242. When cam 221 rotates, cylinder 225 rotates and projections 242 of securing member 240 are locked in place when second locking mechanism is in the locked position. Projections 242 are releasable from the slot in the cylinder 225 when the second locking mechanism is in the unlocked position. In the embodiments shown in FIGS. 19-24, second locking mechanism 220 is in the second portion 272 of housing 270.

Walls 1, 2, 3, 4, 5, 6, 201, 202, 203, 204, 205, 206 and door 7 are made from any material that is light, water resistant, and durable, including for examples, aluminum, plastic, or fiberglass. Optionally, the material from which walls 1, 2, 3, 4, 5, 6, 201, 202, 203, 204, 205, 206 and door 7 are made is also temperature resistant to help keep the temperature of storage compartment 30 from reaching extreme temperatures.

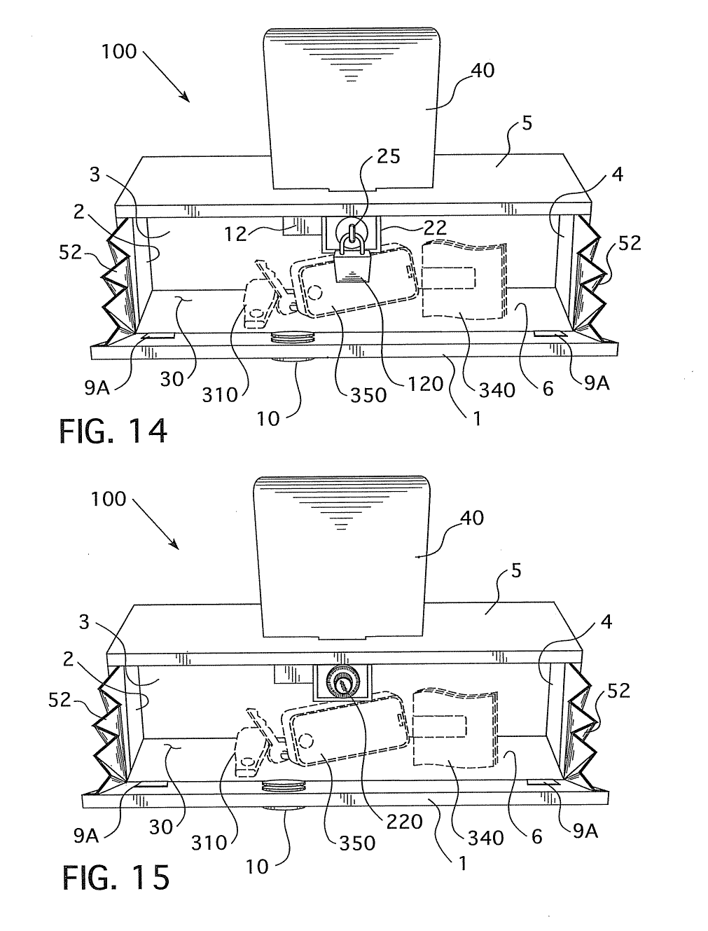

While many of the figures, show first and second locking mechanisms 10, 20, 210, 220 as key locks, first and second locking mechanisms can be any of a key lock (FIGS. 1-11, 19-24), a pad lock 110, 120 (FIGS. 12, 14), a combination lock 310, 320 (FIGS. 13, 15), a touch pad (not shown), a card having a magnetic strip (not shown), or any other means of locking not shown that one skilled in the art could determine is appropriate for these purposes.

Optionally, a sealing means 280 is positioned around a perimeter edge of the moveable member to substantially seal the storage compartment. Sealing means is shown in FIG. 24 as a gasket, but may be means known to those skilled in the art to seal compartment. Sealing means may also be included in locker 100 (not shown).

Optionally, compartment 30, 230 includes a shelf 282 (FIG. 24) or a drawer (not shown).

Optionally, an interior surface of compartment 30, 230 includes a sloped, raised portion 284 positioned substantially near the moveable wall or door.

In embodiments, first and second locking mechanisms 10, 20 and 210, 220 are the same type of lock mechanism but the first locking mechanism 10 or 210 uses a first means of being movable between the locked and unlocked positions and the second locking mechanism 20 or 220 uses a second, different means of being movable between the locked and unlocked positions. For instance, both first and second locking mechanisms 10, 20 or 210, 220 are key locks, but the key to unlock and lock first locking mechanism 10 or 210 is different from the key to unlock and lock second locking mechanism 20 or 220.

While the foregoing has been set forth in considerable detail, it is to be understood that the drawings, detailed embodiments, and examples are presented for elucidation and not limitation. Design variations, especially in matters of shape, size, and arrangements of parts, may be made but are within the principles of the invention. Those skilled in the art will realize that such changes or modifications of the invention or combinations of elements, variations, equivalents, or improvements therein are still within the scope of the invention as defined in the appended claims.

I claim:

1. A locker, comprising:
a. a plurality of walls defining a storage compartment;
b. a first locking mechanism accessible from an exterior of one of said walls having a locked position that secures a moveable member across an opening to said storage compartment; and
c. a second locking mechanism having a locked position that secures a securing member to a rail when said securing member is connected to one of said walls.

2. The locker as in claim 1, wherein said second locking mechanism is accessible from an interior of said storage compartment.

3. The locker as in claim 1, wherein said second locking mechanism is exterior to said storage compartment.

4. The locker as in claim 1, further comprising said securing member.

5. The locker as in claim 1, wherein said moveable member is a door that is coupled to one of said walls.

6. The locker as in claim 1, wherein said moveable member is one of said walls.

7. A locker, comprising:
a. a plurality of walls defining a storage compartment, wherein one of said walls includes a mating member configured to engage a securing member that is configured to engage a rail; and
b. a lock assembly, comprising:
i. a first locking mechanism having a locked position that secures a moveable member in a closed position to make said storage compartment inaccessible;
ii. a second locking mechanism configured to lock said mating member to said securing member to lock said storage compartment to said rail when said mating member and said securing member are engaged.

8. The locker as in claim 7, wherein said moveable member is a door coupled to one of the walls.

9. The locker as in claim 7, wherein said moveable member is a first wall.

10. The locker as in claim 7, wherein said mating member is a female portion that mates with a male portion of said securing member to connect said securing member thereto.

11. A locker in combination with a chair having a rail, comprising:
a. a plurality of walls defining a storage compartment;
b. a moveable member;
c. a first locking mechanism that has a locked position that secures said moveable member across an opening to said storage compartment;
d. a securing member having a first portion configured to engage said rail and a second portion configured to engage a mating member that connects said securing member to said storage compartment; and
e. a second locking mechanism that has a locked position that locks said second portion of said securing member to said mating member to lock said compartment to said rail.

12. The locker as in claim 11, wherein said second locking mechanism is exterior to said storage compartment.

13. The locker as in claim 11, wherein said moveable member is a door secured to one of said walls.

14. The locker as in claim 11, wherein said second locking mechanism is housed in a housing adjacent to one of said walls.

15. A locker, comprising:
a. a plurality of walls defining a storage compartment;
b. a moveable member adjacent to at least one of said walls;
c. a mating member configured to engage a securing member;
d. a first locking mechanism accessible from an exterior of said compartment and having a locked position that secures said moveable member in a closed position across an opening to said storage compartment; and
e. a second locking mechanism adjacent to one of said walls, aligned with said mating member, and having a locked position that locks said mating member to said securing member.

16. The locker as in claim 15, further comprising a housing adjacent to one of said walls, wherein said second locking mechanism is positioned in said housing.

17. The locker as in claim 16, wherein said housing is positioned exterior to said compartment and includes said mating member.

18. The locker as in claim 15, further comprising sealing means positioned around a perimeter edge of said moveable member to substantially seal said compartment.

19. The locker as in claim 15, further comprising a shelf positioned in said compartment.

20. The locker as in claim 15, wherein an interior surface of said compartment includes a sloped, raised portion positioned substantially near said moveable member.

21. The locker as in claim 15, wherein said moveable member is hingedly connected to at least one of said walls.

22. A locker, comprising:
a. a plurality of walls defining a storage compartment;
b. a housing adjacent to at least one of said walls and including a mating member configured to engage a securing member;
c. a moveable member adjacent to at least one of said walls;
d. a first locking mechanism accessible from an exterior of said compartment and having a locked position that secures said moveable member in a closed position across an opening to said storage compartment; and
e. a second locking mechanism having a locked position that locks said mating member to said securing member.

23. The locker as in claim 22, wherein substantially all of said walls are integral.

24. The locker as in claim 22, wherein said housing comprises a first portion that houses said first locking mechanism and a second portion that houses said second locking mechanism, wherein said second portion is accessible from said first portion.

25. The locker as in claim 24, wherein said first portion is connected to said moveable member.

26. The locker as in claim 22, wherein said housing is integral with at least a portion of one of said walls.

27. The locker as in claim 22, wherein an interior surface of said compartment includes a sloped, raised portion substantially near said moveable member.

28. The locker as in claim 22, wherein said moveable member is hingedly connected to at least one of said walls.

29. The locker as in claim 22, further comprising sealing means positioned around a perimeter edge of said moveable member to substantially seal said compartment.

30. The locker as in claim 22, further comprising a shelf positioned in said compartment.

31. The locker as in claim 22, wherein said moveable member moves about an axis that is positioned in a plane in which said compartment is positioned.
